(19) United States
(12) Patent Application Publication
(10) Pub. No.: US 2026/0287125 A1
(43) Pub. Date: Sep. 24, 2026

(54) COMPOSITE DETECTION APPARATUS AND METHOD OF PULSED EDDY CURRENT AND MAGNETIC FLUX LEAKAGE IN OIL AND GAS PIPELINE

(71) Applicant: China Special Equipment Inspection & Research Institute, Beijing (CN)

(72) Inventors: Jinzhong CHEN, Beijing (CN); Jiaxing XIN, Beijing (CN); Ziqing CHEN, Beijing (CN); Chang LIU, Beijing (CN); Runkun LU, Beijing (CN); Yaxing WEN, Beijing (CN)

(21) Appl. No.: 19/573,692

(22) Filed: Mar. 20, 2026

(30) Foreign Application Priority Data
Mar. 24, 2025 (CN) 202510351306.X

(51) Int. Cl. F17D 5/00; G01N 27/90; G01N 27/904

(52) U.S. Cl. CPC F17D 5/005; G01N 27/904; G01N 27/9046

(57) ABSTRACT

This application provides a composite detection apparatus and method of pulsed eddy current and magnetic flux leakage in an oil and gas pipeline, relating to the technical field of in-pipe inspection of oil and gas pipelines. The apparatus includes a pulsed excitation probe. The pulsed excitation probe includes a magnet, a first yoke, a second yoke, an excitation coil, a first receiving coil, a second receiving coil, and a magnetic sensor. The magnet, the first yoke, and the second yoke are configured to apply a static magnetic field to an inner surface of the oil and gas pipeline. The excitation coil is configured to be applied with a pulsed voltage signal. In this application, the advantages of magnetic flux leakage detection and eddy current detection can be combined, achieving defect detection in oil and gas pipelines.

### CROSS REFERENCE TO RELATED APPLICATION

This patent application claims the benefit and priority of Chinese Patent Application No. 202510351306X, filed with the China National Intellectual Property Administration on Mar. 24, 2025, the disclosure of which is incorporated by reference herein in its entirety as part of the present application.

### TECHNICAL FIELD

This application relates to the technical field of in-pipe inspection of oil and gas pipelines, and in particular to a composite detection apparatus and method of pulsed eddy current and magnetic flux leakage in an oil and gas pipeline.

### BACKGROUND

The service environment of oil and gas pipelines is harsh. Due to pressure difference fluctuations of the transported medium, ambient temperature changes, third-party damage, medium scouring and corrosion, and other reasons, pipeline body defects are prone to occur.

Magnetic flux leakage detection technology is sensitive to volumetric defects such as corrosion, and its detection results are reliable. It is the most widely used technology in in-pipe inspection and is known as the cornerstone of the in-pipe inspection industry. However, the conventional magnetic flux leakage in-pipe inspection equipment has a large volume, weight, and magnetic attraction force, and the medium in low-pressure and low-flow-rate oil and gas pipelines has difficulty driving such magnetic flux leakage in-pipe inspection equipment. As a result, this magnetic flux leakage in-pipe inspection equipment cannot be applied to inspection of low-pressure and low-flow-rate oil and gas pipelines. Additionally, the magnetic flux leakage in-pipe inspection equipment can detect crack defects with a large angle to the magnetic field lines, but, due to limitation by the mechanism of magnetic flux leakage detection, it has difficulty in detecting crack defects with a small angle to the magnetic field lines.

Eddy current detection technology has a certain detection capability of both corrosion and crack defects. Specifically, this technology can detect crack defects with a large angle to the magnetic field lines as well as crack defects with a small angle to the magnetic field lines. However, affected by the skin effect, the conventional eddy current in-pipe inspection equipment can detect defects only on the inner surface of oil and gas pipelines, lacking sufficient capability to detect defect depth.

### SUMMARY

An objective of this application is to provide a composite detection apparatus and method of pulsed eddy current and magnetic flux leakage in an oil and gas pipeline, which can combine the advantages of magnetic flux leakage detection and eddy current detection, allowing for simultaneous detection of inner surface corrosion and crack defects as well as outer surface corrosion defects of the oil and gas pipeline. The apparatus features a small volume, light weight, wide application range, and increased eddy current penetration depth, and can detect deeper inner surface corrosion and crack defects.

To achieve the above objective, this application provides the following technical solutions.

According to a first aspect, this application provides a composite detection apparatus of pulsed eddy current and magnetic flux leakage in an oil and gas pipeline, where the composite detection apparatus of pulsed eddy current and magnetic flux leakage in an oil and gas pipeline includes a pulsed excitation probe, and the pulsed excitation probe includes a magnet, a first yoke, a second yoke, an excitation coil, a first receiving coil, a second receiving coil, and a magnetic sensor;
a first end of the first yoke away from an inner surface of the oil and gas pipeline is fixedly mounted on a first end of the magnet, a first end of the second yoke away from the inner surface of the oil and gas pipeline is fixedly mounted on a second end of the magnet, the magnet, the first yoke, and the second yoke are configured to apply a static magnetic field to the inner surface of the oil and gas pipeline;
the excitation coil is sleeved on the magnet, the excitation coil is configured to be applied with a pulsed voltage signal, when the pulsed voltage signal is at a high level, the excitation coil is configured to generate an electromagnetic field, and the electromagnetic field and the static magnetic field are in a same direction, so that the inner surface of the oil and gas pipeline is in a saturation magnetization state, and when the pulsed voltage signal is at a rising edge and a falling edge, the excitation coil is configured to generate a first eddy current field at a position of the inner surface of the oil and gas pipeline corresponding to the first yoke and a second eddy current field at a position corresponding to the second yoke;
the first receiving coil is sleeved on a second end of the first yoke close to the inner surface of the oil and gas pipeline, and the second receiving coil is sleeved on a second end of the second yoke close to the inner surface of the oil and gas pipeline; and the first receiving coil is configured to receive an induced magnetic field generated by the first eddy current field and output a first voltage signal, and the second receiving coil is configured to receive an induced magnetic field generated by the second eddy current field and output a second voltage signal, thereby implementing eddy current detection;
the magnetic sensor is located between the first receiving coil and the second receiving coil, and the magnetic sensor is configured to receive an induced magnetic field generated by the inner surface of the oil and gas pipeline in the saturation magnetization state and output a voltage signal, thereby implementing magnetic flux leakage detection.

Optionally, the composite detection apparatus of pulsed eddy current and magnetic flux leakage in an oil and gas pipeline further includes an integrated electronic system, and the integrated electronic system includes a pulse signal generation module, a pre-power amplification module, a low-pass signal conditioning module, a high-pass signal conditioning module, and a data acquisition and storage module.

The pulse signal generation module is configured to generate a pulse signal.

The pre-power amplification module is connected to both the pulse signal generation module and the excitation coil, and the pre-power amplification module is configured to amplify the pulse signal to obtain a pulsed voltage signal and apply the pulsed voltage signal to the excitation coil.

The low-pass signal conditioning module is connected to the magnetic sensor, and the low-pass signal conditioning module is configured to perform low-pass filtering and amplification on the voltage signal to obtain a low-pass conditioned signal.

The high-pass signal conditioning module is connected to both the first receiving coil and the second receiving coil, and the high-pass signal conditioning module is configured to perform differential processing on the first voltage signal and the second voltage signal to obtain a differential signal, and perform high-pass filtering and amplification on the differential signal to obtain a high-pass conditioned signal.

The data acquisition and storage module is connected to both the low-pass signal conditioning module and the high-pass signal conditioning module, and the data acquisition and storage module is configured to acquire and store the low-pass conditioned signal and the high-pass conditioned signal.

Optionally, the low-pass signal conditioning module includes a low-pass filter unit and a first amplification unit.

The low-pass filter unit is connected to the magnetic sensor, and the low-pass filter unit is configured to perform the low-pass filtering on the voltage signal to obtain a low-pass filtered signal.

The first amplification unit is connected to both the low-pass filter unit and the data acquisition and storage module, and the first amplification unit is configured to amplify the low-pass filtered signal to obtain the low-pass conditioned signal.

Optionally, the high-pass signal conditioning module includes a high-pass filter unit and a second amplification unit.

The high-pass filter unit is connected to both the first receiving coil and the second receiving coil, and the high-pass filter unit is configured to perform the differential processing on the first voltage signal and the second voltage signal to obtain the differential signal, and perform the high-pass filtering on the differential signal to obtain a high-pass filtered signal.

The second amplification unit is connected to both the high-pass filter unit and the data acquisition and storage module, and the second amplification unit is configured to amplify the high-pass filtered signal to obtain the high-pass conditioned signal.

Optionally, the magnet is parallel to an axis of the oil and gas pipeline, the first yoke and the second yoke are both perpendicular to the magnet, the excitation coil is sleeved on a middle of the magnet, the magnetic sensor is located in a middle between the first receiving coil and the second receiving coil, and distances from the magnetic sensor, the first receiving coil, and the second receiving coil to the inner surface of the oil and gas pipeline are the same.

Optionally, defects that are detectable through the eddy current detection include an inner surface crack defect and an inner surface corrosion defect, and defects that are detectable through the magnetic flux leakage detection include an inner surface corrosion defect and an outer surface corrosion defect.

Optionally, a plurality of pulsed excitation probes are provided, and the plurality of pulsed excitation probes are arranged in an array.

A plurality of integrated electronic systems are provided, and one of the integrated electronic systems corresponds to one of the pulsed excitation probes.

Optionally, the composite detection apparatus of pulsed eddy current and magnetic flux leakage in an oil and gas pipeline further includes a detector skeleton and a plurality of probe support arms, and one of the probe support arms corresponds to one of the pulsed excitation probes.

The plurality of probe support arms are all fixedly mounted on the detector skeleton, the plurality of probe support arms are arranged in an array, the pulsed excitation probe is fixedly mounted on the probe support arm, and the plurality of integrated electronic systems are all fixedly mounted on the detector skeleton.

Optionally, the detector skeleton is of a circular cylindrical body, and the plurality of probe support arms are uniformly arranged along a circumferential direction of the detector skeleton.

According to a second aspect, this application provides a composite detection method of pulsed eddy current and magnetic flux leakage in an oil and gas pipeline, which is performed by the composite detection apparatus of pulsed eddy current and magnetic flux leakage in an oil and gas pipeline. The composite detection method of pulsed eddy current and magnetic flux leakage in an oil and gas pipeline includes the following steps:
applying, by the magnet, the first yoke, and the second yoke, the static magnetic field to the inner surface of the oil and gas pipeline;
applying the pulsed voltage signal to the excitation coil, when the pulsed voltage signal is at the high level, generating, by the excitation coil, the electromagnetic field, with the electromagnetic field and the static magnetic field being in the same direction, so that the inner surface of the oil and gas pipeline is in the saturation magnetization state, and when the pulsed voltage signal is at the rising edge and the falling edge, generating, by the excitation coil, the first eddy current field at the position of the inner surface of the oil and gas pipeline corresponding to the first yoke and the second eddy current field at the position corresponding to the second yoke;
receiving, by the first receiving coil, the induced magnetic field generated by the first eddy current field, outputting the first voltage signal, receiving, by the second receiving coil, the induced magnetic field generated by the second eddy current field, and outputting the second voltage signal, thereby implementing the eddy current detection; and
receiving, by the magnetic sensor, the induced magnetic field generated by the inner surface of the oil and gas pipeline in the saturation magnetization state, and outputting the voltage signal, thereby implementing the magnetic flux leakage detection.

According to specific embodiments provided in this application, this application has the following technical effects:

This application provides a composite detection apparatus and method of pulsed eddy current and magnetic flux leakage in an oil and gas pipeline. The apparatus includes a pulsed excitation probe. The pulsed excitation probe includes a magnet, a first yoke, a second yoke, an excitation coil, a first receiving coil, a second receiving coil, and a magnetic sensor. The magnet, the first yoke, and the second yoke are configured to apply a static magnetic field to an inner surface of the oil and gas pipeline. The excitation coil is configured to be applied with a pulsed voltage signal. When the pulsed voltage signal is at a high level, the excitation coil is configured to generate an electromagnetic field. The electromagnetic field and the static magnetic field are in the same direction, so that the inner surface of the oil and gas pipeline is in a saturation magnetization state. At this time, the magnetic sensor is configured to receive an induced magnetic field generated by the inner surface of the oil and gas pipeline in the saturation magnetization state and output a voltage signal, thereby implementing magnetic flux leakage detection. When the pulsed voltage signal is at a rising edge and a falling edge, the excitation coil is configured to generate a first eddy current field at a position of the inner surface of the oil and gas pipeline corresponding to the first yoke and generate a second eddy current field at a position corresponding to the second yoke. At this time, the first receiving coil is configured to receive an induced magnetic field generated by the first eddy current field and output a first voltage signal. The second receiving coil is configured to receive an induced magnetic field generated by the second eddy current field and output a second voltage signal, thereby implementing eddy current detection. The composite detection apparatus of pulsed eddy current and magnetic flux leakage in an oil and gas pipeline designed in this application can simultaneously implement magnetic flux leakage detection and eddy current detection. It can combine the advantages of magnetic flux leakage detection and eddy current detection, simultaneously detect inner surface corrosion and crack defects as well as outer surface corrosion defects of the oil and gas pipeline, and is capable of detecting crack defects with a small angle to the magnetic field lines. Moreover, the excitation coil is configured to provide an electromagnetic field. The electromagnetic field is superimposed with the static magnetic field to saturate and magnetize the inner surface of the oil and gas pipeline. Compared with the manner of completely using the static magnetic field generated by the magnet to saturate and magnetize the inner surface of the oil and gas pipeline, this approach can reduce volume and weight and is suitable for low-pressure and low-flow-rate oil and gas pipelines. Therefore, the apparatus has a small volume, light weight, and a wide application range. Since a static magnetic field is applied to the oil and gas pipeline during eddy current detection, the magnetic permeability of the oil and gas pipeline decreases. At this time, the eddy current penetration depth increases, allowing for detection of deeper inner surface corrosion and crack defects.

### BRIEF DESCRIPTION OF THE DRAWINGS

To describe embodiments of this application or technical solutions in the prior art more clearly, the following briefly describes the accompanying drawings required for the embodiments. Apparently, the accompanying drawings in the following description show merely some embodiments of this application, and a person of ordinary skill in the art may still derive other accompanying drawings from these accompanying drawings without creative efforts.

FIG. 1 is a schematic structural diagram of a pulsed excitation probe according to Embodiment 1 of this application.

FIG. 2 is a schematic three-dimensional structural diagram of the pulsed excitation probe according to Embodiment 1 of this application.

FIG. 3 is a schematic diagram of a processing flow of an integrated electronic system according to Embodiment 1 of this application.

FIG. 4 is a schematic diagram of a working flow of a composite detection apparatus of pulsed eddy current and magnetic flux leakage in an oil and gas pipeline according to Embodiment 1 of this application.

FIG. 5 is a schematic diagram of a working principle of the pulsed excitation probe according to Embodiment 1 of this application.

FIGS. 6A-6B are schematic diagrams of an electromagnetic field generated by the pulsed excitation probe according to Embodiment 1 of this application, where FIG. 6A shows an electromagnetic field generated at a high level, and FIG. 6B shows an electromagnetic field generated at a low level.

FIG. 7 is a schematic diagram of changes in magnetic field strength and magnetic permeability according to Embodiment 1 of this application.

FIG. 8 is a schematic structural diagram of the composite detection apparatus of pulsed eddy current and magnetic flux leakage in an oil and gas pipeline according to Embodiment 1 of this application.

Reference signs in the drawings: 1. first magnet; 2. second magnet; 3. first yoke; 4. second yoke; 5. excitation coil; 6. first receiving coil; 7. second receiving coil; 8. magnetic sensor; 9. detector skeleton; 10. probe support arm; 11. pulsed excitation probe; and 12. integrated electronic system.

### DETAILED DESCRIPTION OF THE EMBODIMENTS

The technical solutions in the embodiments of this application are clearly and completely described below with reference to the drawings in the embodiments of this application. Apparently, the described embodiments are only some rather than all of the embodiments of this application. All other embodiments obtained by a person of ordinary skill in the art based on the embodiments of this application without creative efforts shall fall within the protection scope of this application.

### Embodiment 1

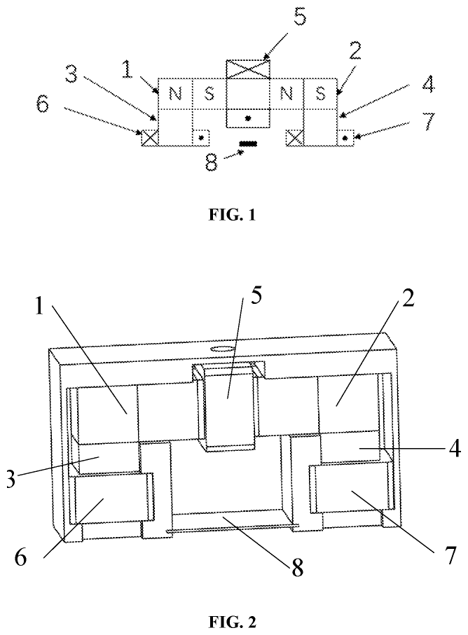

This embodiment provides a composite detection apparatus of pulsed eddy current and magnetic flux leakage in an oil and gas pipeline. As shown in FIG. 1 and FIG. 2, the composite detection apparatus of pulsed eddy current and magnetic flux leakage in an oil and gas pipeline includes a pulsed excitation probe, and the pulsed excitation probe includes a magnet, a first yoke 3, a second yoke 4, an excitation coil 5, a first receiving coil 6, a second receiving coil 7, and a magnetic sensor 8.

A first end of the first yoke 3 away from an inner surface of the oil and gas pipeline is fixedly mounted on a first end of the magnet, a first end of the second yoke 4 away from the inner surface of the oil and gas pipeline is fixedly mounted on a second end of the magnet, and the magnet, the first yoke 3, and the second yoke 4 are configured to apply a static magnetic field to the inner surface of the oil and gas pipeline.

The excitation coil 5 is sleeved on the magnet. The excitation coil 5 is configured to be applied with a pulsed voltage signal. When the pulsed voltage signal is at a high level, the excitation coil 5 is configured to generate an electromagnetic field. The excitation coil 5, the first yoke 3, and the second yoke 4 are configured to apply the electromagnetic field to the inner surface of the oil and gas pipeline. The electromagnetic field and the static magnetic field are in a same direction, so that the inner surface of the oil and gas pipeline is in a saturation magnetization state. When the pulsed voltage signal is at a rising edge and a falling edge, the excitation coil 5 is configured to generate a first eddy current field at a position of the inner surface of the oil and gas pipeline corresponding to the first yoke 3 and generate a second eddy current field at a position corresponding to the second yoke 4.

The first receiving coil 6 is sleeved on a second end of the first yoke 3 close to the inner surface of the oil and gas pipeline. The second receiving coil 7 is sleeved on a second end of the second yoke 4 close to the inner surface of the oil and gas pipeline. The first receiving coil 6 is configured to receive an induced magnetic field generated by the first eddy current field and output a first voltage signal, and the second receiving coil 7 is configured to receive an induced magnetic field generated by the second eddy current field and output a second voltage signal, thereby implementing eddy current detection.

The magnetic sensor 8 is located between the first receiving coil 6 and the second receiving coil 7. The magnetic sensor 8 is configured to receive an induced magnetic field generated by the inner surface of the oil and gas pipeline in the saturation magnetization state and output a voltage signal, thereby implementing magnetic flux leakage detection.

In this embodiment, the magnet may be composed of a plurality of magnets. For example, as shown in FIG. 1, the magnet includes a first magnet 1 and a second magnet 2.

The core components of the pulsed excitation probe in this embodiment include a magnet, a first yoke 3, a second yoke 4, an excitation coil 5, a first receiving coil 6, a second receiving coil 7, and a magnetic sensor 8. The magnet provides a static magnetic field for the pulsed excitation probe, reduces the magnetic permeability of the oil and gas pipeline, and increases the penetration depth of the eddy current field. The first yoke 3 and the second yoke 4 can guide the magnetic field generated by the magnet and the excitation coil 5 into the oil and gas pipeline and are also part of a local magnetic circuit. The excitation coil 5 serves as a carrier for generating a pulsed magnetic field (including the electromagnetic field generated at a high level, and the changing magnetic fields generated at the rising edge and the falling edge). The pulsed magnetic field is generated under the excitation of the pulsed voltage signal. The winding direction of the excitation coil 5 needs to satisfy that the direction of the electromagnetic field generated by the excitation coil 5 at the high level remains consistent with the direction of the static magnetic field generated by the magnet. The winding directions of the first receiving coil 6 and the second receiving coil 7 are the same. When the excitation coil 5 generates changing magnetic fields at the rising edge and the falling edge, causing the oil and gas pipeline to generate a first eddy current field and a second eddy current field, the first receiving coil 6 and the second receiving coil 7 respectively receive the induced magnetic fields excited by the first eddy current field and the second eddy current field to implement eddy current detection. When the excitation coil 5 generates an electromagnetic field at the high level, causing the oil and gas pipeline to be in a saturation magnetization state, the magnetic sensor 8 receives the induced magnetic field leaking into the space to implement magnetic flux leakage detection.

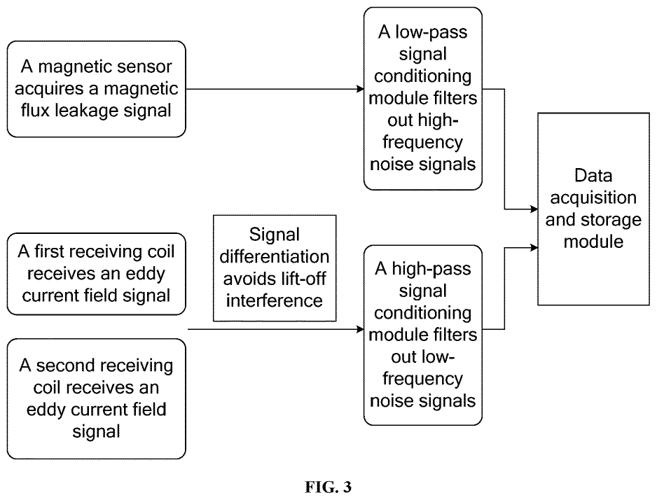

As shown in FIG. 3, the composite detection apparatus of pulsed eddy current and magnetic flux leakage in an oil and gas pipeline in this embodiment further includes an integrated electronic system. The integrated electronic system includes a pulse signal generation module, a pre-power amplification module, a low-pass signal conditioning module, a high-pass signal conditioning module, and a data acquisition and storage module.

The pulse signal generation module is configured to generate a pulse signal, and the pulse signal may be a pulse square wave signal.

The pre-power amplification module is connected to both the pulse signal generation module and the excitation coil 5. The pre-power amplification module is configured to amplify the pulse signal, provide energy to the pulse signal to obtain a pulsed voltage signal, and apply the pulsed voltage signal to the excitation coil 5 to drive the excitation coil 5 to generate a pulsed magnetic field.

The low-pass signal conditioning module is connected to the magnetic sensor 8. The low-pass signal conditioning module is configured to perform low-pass filtering and amplification on the voltage signal output by the magnetic sensor 8 to obtain a low-pass conditioned signal.

The high-pass signal conditioning module is connected to both the first receiving coil 6 and the second receiving coil 7. The high-pass signal conditioning module is configured to perform differential processing on the first voltage signal output by the first receiving coil 6 and the second voltage signal output by the second receiving coil 7 to obtain a differential signal, and perform high-pass filtering and amplification on the differential signal to obtain a high-pass conditioned signal.

The data acquisition and storage module is connected to both the low-pass signal conditioning module and the high-pass signal conditioning module. The data acquisition and storage module is configured to acquire and store the low-pass conditioned signal and the high-pass conditioned signal.

Considering that conventional eddy current in-pipe inspection equipment is severely affected by the lift-off effect during application, resulting in insufficient accuracy of defect detection, differential processing is designed in this embodiment, improving detection accuracy.

The low-pass signal conditioning module includes a low-pass filter unit and a first amplification unit. The low-pass filter unit is connected to the magnetic sensor 8. The low-pass filter unit is configured to perform low-pass filtering on the voltage signal output by the magnetic sensor 8 to obtain a low-pass filtered signal. The first amplification unit is connected to both the low-pass filter unit and the data acquisition and storage module. The first amplification unit is configured to amplify the low-pass filtered signal to obtain a low-pass conditioned signal, and transmit the low-pass conditioned signal to the data acquisition and storage module.

The low-pass signal conditioning module in this embodiment includes a low-pass filtering part and an amplification part. The voltage signal input from the magnetic sensor 8 to the low-pass signal conditioning module contains high-frequency electromagnetic noise in the space, which can be filtered out by the low-pass filtering part, and the low-frequency magnetic flux leakage field signal corresponding to the pipeline defect passes through, thereby implementing magnetic flux leakage detection.

The high-pass signal conditioning module includes a high-pass filter unit and a second amplification unit. The high-pass filter unit is connected to both the first receiving coil 6 and the second receiving coil 7. The high-pass filter unit is configured to perform differential processing on the first voltage signal output by the first receiving coil 6 and the second voltage signal output by the second receiving coil 7 to obtain a differential signal, and perform high-pass filtering on the differential signal to obtain a high-pass filtered signal. The second amplification unit is connected to both the high-pass filter unit and the data acquisition and storage module. The second amplification unit is configured to amplify the high-pass filtered signal to obtain a high-pass conditioned signal, and transmit the high-pass conditioned signal to the data acquisition and storage module.

The high-pass signal conditioning module in this embodiment includes a high-pass filtering part and an amplification part. The first voltage signal and the second voltage signal output from the first receiving coil 6 and the second receiving coil 7 are first subjected to differential processing after being input to the high-pass signal conditioning module. The obtained original differential signal contains low-frequency electromagnetic noise in the space, which can be filtered out by the high-pass filtering part, and the high-frequency eddy current field signal corresponding to the pipeline defect passes through, thereby implementing eddy current detection.

In this embodiment, the magnet may be parallel to the axis of the oil and gas pipeline. Both the first yoke 3 and the second yoke 4 may be perpendicular to the magnet. The excitation coil 5 may be sleeved in the middle of the magnet. The magnetic sensor 8 may be located in the middle between the first receiving coil 6 and the second receiving coil 7. Distances from the magnetic sensor 8, the first receiving coil 6, and the second receiving coil 7 to the inner surface of the oil and gas pipeline may be the same.

In this embodiment, the pulsed excitation probe may include a housing. After the magnet, the first yoke 3, the second yoke 4, the excitation coil 5, the first receiving coil 6, the second receiving coil 7, and the magnetic sensor 8 are mounted in the housing, all components are completely cured using epoxy resin or similar adhesive. During the detection process, the positions of the magnet, the first yoke 3, the second yoke 4, the excitation coil 5, the first receiving coil 6, the second receiving coil 7, and the magnetic sensor 8 remain unchanged.

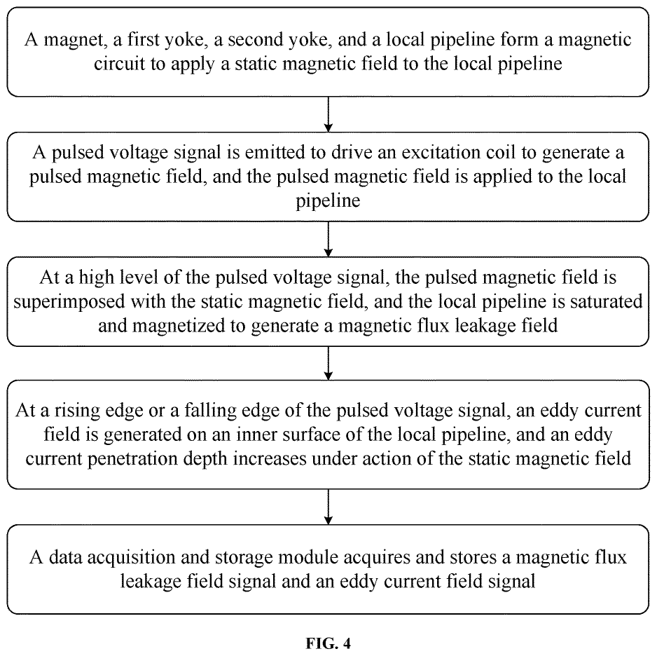

As shown in FIG. 4, in this embodiment, during detection, the composite detection apparatus of pulsed eddy current and magnetic flux leakage in an oil and gas pipeline is placed into the oil and gas pipeline to be tested. The magnet is configured to generate a static magnetic field. The first yoke 3 and the second yoke 4 are configured to apply the static magnetic field generated by the magnet to the inner surface of the oil and gas pipeline. Therefore, the magnet, the first yoke 3, and the second yoke 4 are configured to apply a static magnetic field to the inner surface of the oil and gas pipeline. The magnetic field strength of the static magnetic field is H₁. At this time, a magnetic field circuit is formed by the magnet, the first yoke 3, and the second yoke 4 that are inside the pulsed excitation probe, together with the local oil and gas pipeline covered by the magnet, the first yoke 3, and the second yoke 4, so that the inner surface of the oil and gas pipeline is in a static magnetization state. The magnetic permeability of the local oil and gas pipeline covered by the magnet, the first yoke 3, and the second yoke 4 decreases to μ₁.

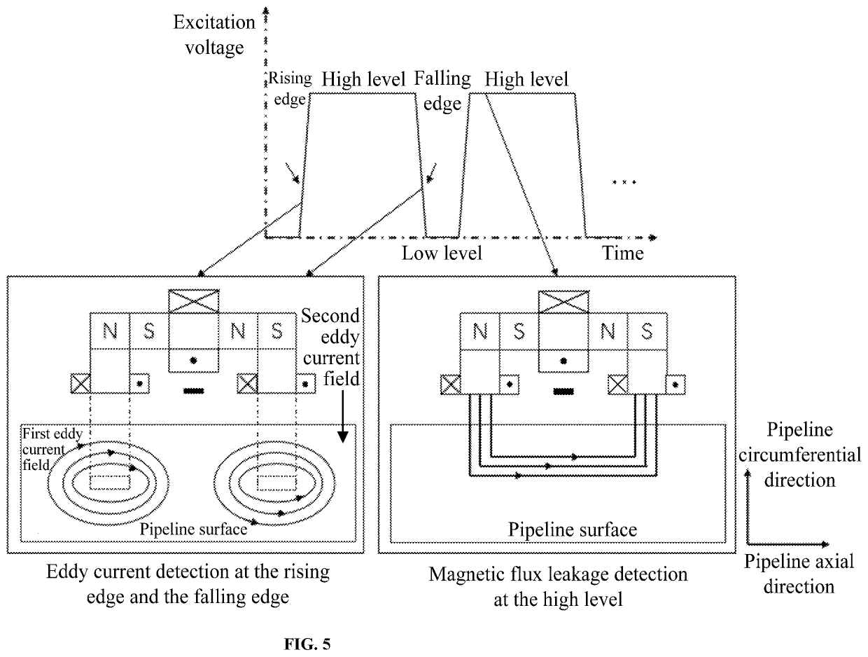

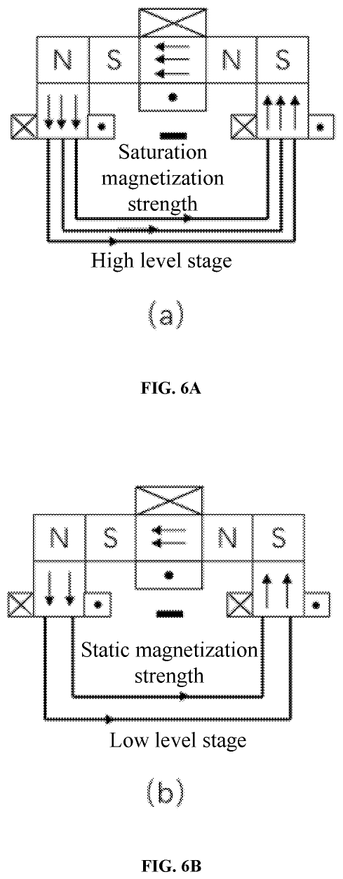

As shown in FIGS. 5 and 6, the excitation coil 5 is configured to be applied with a pulsed voltage signal. The pulsed voltage signal is a variation curve of the excitation voltage over time. The pulsed voltage signal includes a rising edge, a high level, a falling edge, and a low level. When the pulsed voltage signal is at the high level, the excitation coil 5 generates an electromagnetic field. The magnetic field strength of the electromagnetic field is H₂, and the electromagnetic field and the static magnetic field are in the same direction. The excitation coil 5, the first yoke 3, and the second yoke 4 are configured to apply the electromagnetic field to the inner surface of the oil and gas pipeline. In the local oil and gas pipeline covered by the magnet, the first yoke 3, and the second yoke 4, the electromagnetic field and the static magnetic field are vectorially superimposed. The magnetic field strength after superposition reaches the saturation magnetization strength Hₛ, saturating and magnetizing the inner surface of the oil and gas pipeline, so that the inner surface of the oil and gas pipeline is in a saturation magnetization state. When the pulsed voltage signal is at the rising edge and the falling edge, that is, when the excitation coil 5 is applied with excitation voltages of the rising edge and falling edge, the electromagnetic field generated by the excitation coil 5 undergoes transient changes, that is, changing magnetic fields are generated. According to Faraday's law of electromagnetic induction, two eddy current fields in opposite directions are generated at positions of the inner surface of the oil and gas pipeline corresponding to the first yoke 3 and the second yoke 4, that is, a first eddy current field and a second eddy current field are generated at the inner surface of the oil and gas pipeline. The position of the first eddy current field corresponds to the position of the first yoke 3, the position of the second eddy current field corresponds to the position of the second yoke 4, and the directions of the first eddy current field and the second eddy current field are opposite. When the pulsed voltage signal is at the low level, the excitation coil 5 does not generate an electromagnetic field.

The induced magnetic fields excited by the first eddy current field and the second eddy current field hinder the change trend of the electromagnetic field. When crack defects and corrosion defects appear on the inner surface of the oil and gas pipeline, the magnetic fluxes in the first receiving coil 6 and the second receiving coil 7 change, and the corresponding first voltage signal and second voltage signal are output. At this time, the first voltage signal and the second voltage signal are eddy current field signals. That is, the first receiving coil 6 is configured to receive the induced magnetic field generated by the first eddy current field and output the first voltage signal. The second receiving coil 7 is configured to receive the induced magnetic field generated by the second eddy current field and output the second voltage signal. After the first voltage signal and the second voltage signal undergo differential processing, high-pass filtering, and amplification by the high-pass signal conditioning module, they are input to the data acquisition and storage module. Crack defects and corrosion defects on the inner surface of the oil and gas pipeline are detected via the obtained high-pass conditioned signal, thereby implementing eddy current detection.

During eddy current detection, since the inner surface of the oil and gas pipeline is in a static magnetization state and the magnetic permeability is reduced to μ₁, the eddy current further penetrates into the pipe wall. Therefore, when the eddy current detection is performed, the eddy current field signal carries deeper defect information.

When volumetric defects such as inner surface corrosion and outer surface corrosion exist, the internal magnetic field of the inner surface of the oil and gas pipeline in the saturation magnetization state leaks into the space and is captured by the magnetic sensor 8, which outputs a corresponding voltage signal. At this time, the voltage signal is a magnetic flux leakage field signal. That is, the magnetic sensor 8 is configured to receive the induced magnetic field generated by the inner surface of the oil and gas pipeline in the saturation magnetization state and output a voltage signal. After the voltage signal undergoes low-pass filtering and amplification by the low-pass signal conditioning module, it is input to the data acquisition and storage module. Volumetric defects of the oil and gas pipeline and crack defects with a large angle to the magnetic field lines are detected via the obtained low-pass conditioned signal, thereby implementing magnetic flux leakage detection.

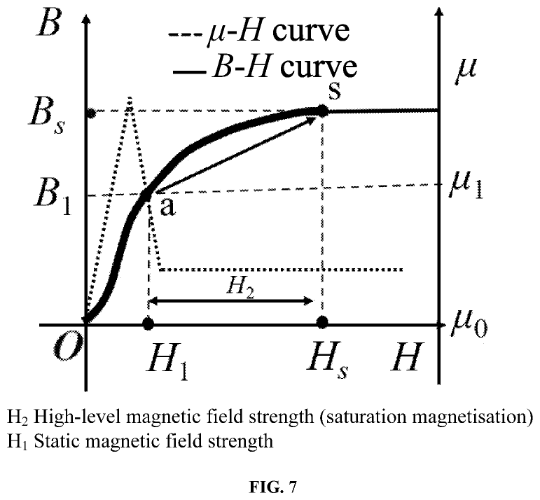

As shown in FIG. 7, it is a schematic diagram of the changes in the magnetic permeability (μ) and magnetic induction intensity (also known as magnetic flux density, B) of the oil and gas pipeline with the magnetic field strength (H) during the detection process. When the oil and gas pipeline is in an unmagnetized state, the magnetic field strength is 0, the magnetic induction intensity is 0, and the magnetic permeability is μ₀. When the oil and gas pipeline is in a static magnetization state, the magnetic field strength is H₁, the magnetic induction intensity is B₁, and the magnetic permeability decreases to μ₁. When the pulsed voltage signal is at the high level, the magnetic field strength of the generated electromagnetic field is H₂, the oil and gas pipeline is saturated and magnetized, and the magnetic field strength applied to the oil and gas pipeline is the vector superposition of H₁ and H₂, which is the saturation magnetization strength Hₛ. At this time, it is the magnetic flux leakage detection stage, the magnetic induction intensity is Bs, and the magnetic permeability is further reduced. When the pulsed voltage signal is at the rising edge and the falling edge, two eddy current fields are generated on the surface of the oil and gas pipeline. At this time, it is the eddy current detection stage, the magnetic induction intensity is B₁, and the magnetic permeability is μ₁.

The calculation formula of eddy current penetration depth is:

$$δ = \sqrt{\frac{ρ}{π f μ}} ,$$

where δ is the eddy current penetration depth; ρ is the resistivity of the conductor; f is the frequency of the alternating magnetic field; and μ is the magnetic permeability of the conductor.

Obviously, when the magnetic permeability decreases, the eddy current penetration depth increases, which proves that the pulsed excitation probe in this embodiment has the advantage of increasing the eddy current penetration depth.

In this embodiment, defects that are detectable through the eddy current detection include inner surface crack defects and inner surface corrosion defects. Defects that are detectable through the magnetic flux leakage detection include inner surface corrosion defects and outer surface corrosion defects. Inner surface crack defects and outer surface crack defects with a large angle to the magnetic field lines can also be detected.

Magnetic flux leakage in-pipe inspection equipment can detect volumetric defects such as inner and outer corrosion of oil and gas pipelines. However, since the detection probe is separated from the pipe segment magnetization device in magnetic flux leakage in-pipe inspection equipment, the detection probe is located in the middle of the pipe segment magnetization device. The pipe segment magnetization device applies saturation magnetization to a section of the pipeline, but the detection probe only extracts magnetic field information from the region covered by the detection probe. Therefore, applying saturation magnetization to regions not covered by the detection probe by the pipe segment magnetization device is equivalent to wasted effort, resulting in a waste of magnetic field resources. Moreover, applying saturation magnetization to part of the pipe segment by the pipe segment magnetization device in magnetic flux leakage in-pipe inspection equipment requires a huge magnet volume, leading to enormous volume and weight of the magnetic flux leakage in-pipe inspection equipment, and making it difficult to apply to low-pressure and low-flow-rate oil and gas pipelines. At the same time, limited by the detection mechanism, magnetic flux leakage in-pipe inspection equipment has difficulty detecting crack defects with a small angle to the magnetic field lines. The eddy current in-pipe inspection equipment can detect crack and corrosion defects on the inner surface of oil and gas pipelines. It can detect both crack defects with a large angle to the magnetic field lines and crack defects with a small angle to the magnetic field lines. However, since oil and gas pipelines are generally made of ferromagnetic materials with high magnetic permeability, the penetration depth of eddy currents is insufficient, making it difficult to detect deeper defect information on the inner surface of oil and gas pipelines. In order to solve this problem, in this embodiment, based on the combination of the advantages of the conventional magnetic flux leakage and eddy current detection technologies, a composite detection apparatus of pulsed eddy current and magnetic flux leakage in an oil and gas pipeline is proposed. The pipe segment magnetization device (that is, the magnet and the excitation coil 5) is integrated with the detection probe (that is, the magnetic sensor 8). Saturation magnetization is applied to the region covered by the detection probe by superimposing pulsed excitation (that is, pulsed voltage signal) on the static magnetic field, that is, saturation magnetization is applied and magnetic field information is extracted only in the region covered by the detection probe, avoiding waste of magnetic field resources. When at the high level of pulsed excitation, the electromagnetic field of the excitation coil 5 is superimposed with the static magnetic field of the magnet to apply saturation magnetization to the region covered by the detection probe. When volumetric defects exist, the magnetic sensor 8 captures changes in the magnetic flux leakage field in space to implement magnetic flux leakage detection. Compared with the manner of completely using the static magnetic field generated by the magnet to saturate and magnetize the inner surface of the oil and gas pipeline, this approach can reduce volume and weight, is suitable for low-pressure and low-flow-rate oil and gas pipelines, and has a wide application range. When at the rising edge and the falling edge of pulsed excitation, the electromagnetic field of the excitation coil 5 undergoes transient changes, causing two eddy current fields in opposite directions to be generated at the inner surface of the oil and gas pipeline, which can effectively detect crack and corrosion defects on the inner pipe wall, thereby implementing eddy current detection. At the same time, a static magnetic field exists in the region covered by the probe, the magnetic permeability of the oil and gas pipeline decreases, the eddy current penetration depth increases, and effective acquisition of deeper defect information on the inner wall of the oil and gas pipeline is achieved.

This embodiment has the following advantages.

(1) During saturation magnetization (implemented with the static magnetic field and electromagnetic field at the high level stage) of the oil and gas pipeline, saturation magnetization is applied only to the region covered by the probe. Therefore, compared with the conventional magnetic flux leakage in-pipe inspection equipment that applies saturation magnetization to the entire part of the pipe segment, this avoids waste of magnetic field resources and significantly reduces volume and weight.

(2) When pulsed excitation is at the rising edge and falling edge stage, the eddy current field generated at the inner surface of the oil and gas pipeline benefits from the reduction in magnetic permeability caused by the static magnetic field, resulting in increased eddy current penetration depth and enabling the eddy current field signal to carry deeper defect information.

(3) The pulsed excitation probe combines the advantages of magnetic flux leakage and eddy current technologies, enabling detection of inner cracks, inner and outer corrosion defects in the pipeline as well as discrimination of defect locations, thereby improving the efficiency and accuracy of in-pipe inspection.

In this embodiment, a plurality of pulsed excitation probes are provided, and the plurality of pulsed excitation probes are arranged in an array. A plurality of integrated electronic systems are provided, and one integrated electronic system corresponds to one pulsed excitation probe.

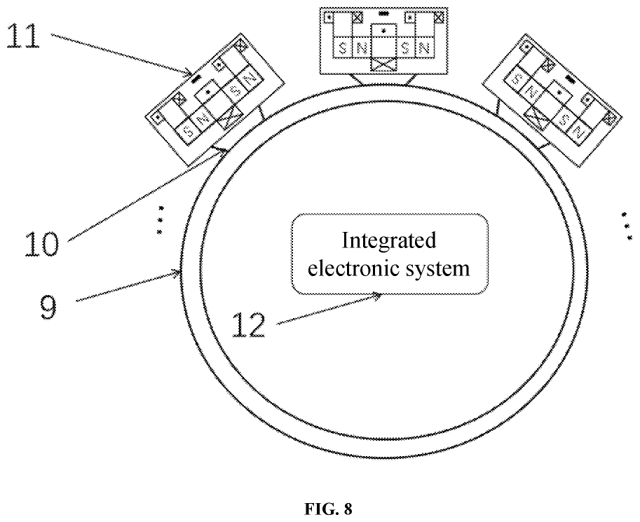

As shown in FIG. 8, the composite detection apparatus of pulsed eddy current and magnetic flux leakage in an oil and gas pipeline in this embodiment further includes a detector skeleton 9 and a plurality of probe support arms 10. One probe support arm 10 corresponds to one pulsed excitation probe 11. The plurality of probe support arms 10 are all fixedly mounted on the detector skeleton 9, and the plurality of probe support arms 10 are arranged in an array. The pulsed excitation probes 11 are fixedly mounted on the probe support arms 10, and the plurality of integrated electronic systems 12 are all fixedly mounted on the detector skeleton 9.

In this embodiment, the detector skeleton 9 is of a circular cylindrical body, and the plurality of probe support arms 10 are uniformly arranged along a circumferential direction of the detector skeleton 9.

The detector skeleton 9 may be made of steel to provide a mounting carrier and rigid support for the probe support arms 10, the integrated electronic systems 12, and the like. The probe support arms 10 may be made of steel to connect the pulsed excitation probes 11 with the detector skeleton 9.

The composite detection apparatus of pulsed eddy current and magnetic flux leakage in an oil and gas pipeline proposed in this embodiment combines the advantages of magnetic flux leakage and eddy current technologies. The placed magnet forms a magnetic circuit with the first yoke 3, the second yoke 4, and the local pipeline, allowing the probe to closely adhere to the pipe wall, reducing lift-off noise caused by probe vibration, while applying a static magnetic field to reduce the magnetic permeability. At the high level stage, precise saturation magnetization is applied to the region covered by the probe, saving magnetic field resources, reducing volume and weight, and achieving detection of volumetric defects on the inner and outer walls of the oil and gas pipeline. At the rising edge and falling edge stage, eddy current detection is performed on the region covered by the probe, which can effectively detect volumetric defects and cracks on the inner pipe wall. Since eddy current detection is superimposed on the static magnetic field, the magnetic permeability of the pipeline is reduced to μ₁, increasing the penetration depth of the eddy current and enabling the magnetic field excited by the eddy current to carry deeper defect information. Receiving eddy current field signals through coil differential processing can avoid the influence of probe lift-off and electromagnetic interference on the eddy current field signals, thereby improving defect identification accuracy.

### Embodiment 2

This embodiment provides a composite detection method of pulsed eddy current and magnetic flux leakage in an oil and gas pipeline, performed by the composite detection apparatus of pulsed eddy current and magnetic flux leakage in an oil and gas pipeline described in Embodiment 1. The composite detection method of pulsed eddy current and magnetic flux leakage in an oil and gas pipeline includes the following steps.

(1) The magnet, the first yoke, and the second yoke apply the static magnetic field to the inner surface of the oil and gas pipeline.

(2) The excitation coil applies the pulsed voltage signal, when the pulsed voltage signal is at the high level, the excitation coil generates the electromagnetic field, with the electromagnetic field and the static magnetic field being in the same direction, so that the inner surface of the oil and gas pipeline is in the saturation magnetization state, and when the pulsed voltage signal is at the rising edge and the falling edge, the excitation coil generates the first eddy current field at the position of the inner surface of the oil and gas pipeline corresponding to the first yoke and the second eddy current field at the position corresponding to the second yoke.

(3) The first receiving coil receives the induced magnetic field generated by the first eddy current field and outputs the first voltage signal, and the second receiving coil receives the induced magnetic field generated by the second eddy current field and outputs the second voltage signal, thereby implementing the eddy current detection.

(4) The magnetic sensor receives the induced magnetic field generated by the inner surface of the oil and gas pipeline in the saturation magnetization state and outputs the voltage signal, thereby implementing the magnetic flux leakage detection.

The various technical features of the above embodiments can be combined arbitrarily. For the sake of conciseness in description, all possible combinations of the various technical features in the above embodiments are not described. However, as long as there is no contradiction in the combinations of these technical features, they should be considered to fall within the scope recorded in this specification.

Several examples are used herein for illustration of the principles and implementations of this application. The description of the foregoing embodiments is used to help illustrate the method of this application and the core principles thereof. In addition, those of ordinary skill in the art can make various modifications in terms of specific implementations and scope of application in accordance with the teachings of this application. In conclusion, the content of the present specification shall not be construed as a limitation to this application.

What is claimed is:

1. A composite detection apparatus of pulsed eddy current and magnetic flux leakage in an oil and gas pipeline, wherein the composite detection apparatus of pulsed eddy current and magnetic flux leakage in an oil and gas pipeline comprises a pulsed excitation probe, and the pulsed excitation probe comprises a magnet, a first yoke, a second yoke, an excitation coil, a first receiving coil, a second receiving coil, and a magnetic sensor;
a first end of the first yoke away from an inner surface of the oil and gas pipeline is fixedly mounted on a first end of the magnet, a first end of the second yoke away from the inner surface of the oil and gas pipeline is fixedly mounted on a second end of the magnet, and the magnet, the first yoke, and the second yoke are configured to apply a static magnetic field to the inner surface of the oil and gas pipeline;
the excitation coil is sleeved on the magnet, the excitation coil is configured to be applied with a pulsed voltage signal, when the pulsed voltage signal is at a high level, the excitation coil is configured to generate an electromagnetic field, and the electromagnetic field and the static magnetic field are in a same direction, so that the inner surface of the oil and gas pipeline is in a saturation magnetization state, and when the pulsed voltage signal is at a rising edge and a falling edge, the excitation coil is configured to generate a first eddy current field at a position of the inner surface of the oil and gas pipeline corresponding to the first yoke and a second eddy current field at a position corresponding to the second yoke;
the first receiving coil is sleeved on a second end of the first yoke close to the inner surface of the oil and gas pipeline, and the second receiving coil is sleeved on a second end of the second yoke close to the inner surface of the oil and gas pipeline; and the first receiving coil is configured to receive an induced magnetic field generated by the first eddy current field and output a first voltage signal, and the second receiving coil is configured to receive an induced magnetic field generated by the second eddy current field and output a second voltage signal, thereby implementing eddy current detection; and
the magnetic sensor is located between the first receiving coil and the second receiving coil, and the magnetic sensor is configured to receive an induced magnetic field generated by the inner surface of the oil and gas pipeline in the saturation magnetization state and output a voltage signal, thereby implementing magnetic flux leakage detection.

2. The composite detection apparatus of pulsed eddy current and magnetic flux leakage in an oil and gas pipeline according to claim 1, wherein the composite detection apparatus of pulsed eddy current and magnetic flux leakage in an oil and gas pipeline further comprises an integrated electronic system, and the integrated electronic system comprises a pulse signal generation module, a pre-power amplification module, a low-pass signal conditioning module, a high-pass signal conditioning module, and a data acquisition and storage module;
the pulse signal generation module is configured to generate a pulse signal;
the pre-power amplification module is connected to both the pulse signal generation module and the excitation coil, and the pre-power amplification module is configured to amplify the pulse signal to obtain a pulsed voltage signal and apply the pulsed voltage signal to the excitation coil;
the low-pass signal conditioning module is connected to the magnetic sensor, and the low-pass signal conditioning module is configured to perform low-pass filtering and amplification on the voltage signal to obtain a low-pass conditioned signal;
the high-pass signal conditioning module is connected to both the first receiving coil and the second receiving coil, and the high-pass signal conditioning module is configured to perform differential processing on the first voltage signal and the second voltage signal to obtain a differential signal, and perform high-pass filtering and amplification on the differential signal to obtain a high-pass conditioned signal; and
the data acquisition and storage module is connected to both the low-pass signal conditioning module and the high-pass signal conditioning module, and the data acquisition and storage module is configured to acquire and store the low-pass conditioned signal and the high-pass conditioned signal.

3. The composite detection apparatus of pulsed eddy current and magnetic flux leakage in an oil and gas pipeline according to claim 2, wherein the low-pass signal conditioning module comprises a low-pass filter unit and a first amplification unit;
the low-pass filter unit is connected to the magnetic sensor, and the low-pass filter unit is configured to perform the low-pass filtering on the voltage signal to obtain a low-pass filtered signal; and
the first amplification unit is connected to both the low-pass filter unit and the data acquisition and storage module, and the first amplification unit is configured to amplify the low-pass filtered signal to obtain the low-pass conditioned signal.

4. The composite detection apparatus of pulsed eddy current and magnetic flux leakage in an oil and gas pipeline according to claim 2, wherein the high-pass signal conditioning module comprises a high-pass filter unit and a second amplification unit;
the high-pass filter unit is connected to both the first receiving coil and the second receiving coil, and the high-pass filter unit is configured to perform the differential processing on the first voltage signal and the second voltage signal to obtain the differential signal, and perform the high-pass filtering on the differential signal to obtain a high-pass filtered signal; and
the second amplification unit is connected to both the high-pass filter unit and the data acquisition and storage module, and the second amplification unit is configured to amplify the high-pass filtered signal to obtain the high-pass conditioned signal.

5. The composite detection apparatus of pulsed eddy current and magnetic flux leakage in an oil and gas pipeline according to claim 1, wherein the magnet is parallel to an axis of the oil and gas pipeline, the first yoke and the second yoke are both perpendicular to the magnet, the excitation coil is sleeved on a middle of the magnet, the magnetic sensor is located in a middle between the first receiving coil and the second receiving coil, and distances from the magnetic sensor, the first receiving coil, and the second receiving coil to the inner surface of the oil and gas pipeline are the same.

6. The composite detection apparatus of pulsed eddy current and magnetic flux leakage in an oil and gas pipeline according to claim 1, wherein defects that are detectable through the eddy current detection comprise an inner surface crack defect and an inner surface corrosion defect, and defects that are detectable through the magnetic flux leakage detection comprise an inner surface corrosion defect and an outer surface corrosion defect.

7. The composite detection apparatus of pulsed eddy current and magnetic flux leakage in an oil and gas pipeline according to claim 2, wherein a plurality of pulsed excitation probes are provided, and the plurality of pulsed excitation probes are arranged in an array; and
a plurality of integrated electronic systems are provided, and one of the integrated electronic systems corresponds to one of the pulsed excitation probes.

8. The composite detection apparatus of pulsed eddy current and magnetic flux leakage in an oil and gas pipeline according to claim 7, wherein the composite detection apparatus of pulsed eddy current and magnetic flux leakage in an oil and gas pipeline further comprises a detector skeleton and a plurality of probe support arms, and one of the probe support arms corresponds to one of the pulsed excitation probes; and
the plurality of probe support arms are all fixedly mounted on the detector skeleton, the plurality of probe support arms are arranged in an array, the pulsed excitation probe is fixedly mounted on the probe support arm, and the plurality of integrated electronic systems are all fixedly mounted on the detector skeleton.

9. The composite detection apparatus of pulsed eddy current and magnetic flux leakage in an oil and gas pipeline according to claim 8, wherein the detector skeleton is of a circular cylindrical body, and the plurality of probe support arms are uniformly arranged along a circumferential direction of the detector skeleton.

10. A composite detection method of pulsed eddy current and magnetic flux leakage in an oil and gas pipeline, performed by the composite detection apparatus of pulsed eddy current and magnetic flux leakage in an oil and gas pipeline according to claim 1, wherein the composite detection method of pulsed eddy current and magnetic flux leakage in an oil and gas pipeline comprises:
applying, by the magnet, the first yoke, and the second yoke, the static magnetic field to the inner surface of the oil and gas pipeline;
applying the pulsed voltage signal to the excitation coil, when the pulsed voltage signal is at the high level, generating, by the excitation coil, the electromagnetic field, with the electromagnetic field and the static magnetic field being in the same direction, so that the inner surface of the oil and gas pipeline is in the saturation magnetization state, and when the pulsed voltage signal is at the rising edge and the falling edge, generating, by the excitation coil, the first eddy current field at the position of the inner surface of the oil and gas pipeline corresponding to the first yoke and the second eddy current field at the position corresponding to the second yoke;
receiving, by the first receiving coil, the induced magnetic field generated by the first eddy current field, outputting the first voltage signal, receiving, by the second receiving coil, the induced magnetic field generated by the second eddy current field, and outputting the second voltage signal, thereby implementing the eddy current detection; and
receiving, by the magnetic sensor, the induced magnetic field generated by the inner surface of the oil and gas pipeline in the saturation magnetization state, and outputting the voltage signal, thereby implementing the magnetic flux leakage detection.

11. The composite detection method according to claim 10, wherein the composite detection apparatus of pulsed eddy current and magnetic flux leakage in an oil and gas pipeline further comprises an integrated electronic system, and the integrated electronic system comprises a pulse signal generation module, a pre-power amplification module, a low-pass signal conditioning module, a high-pass signal conditioning module, and a data acquisition and storage module;
the pulse signal generation module is configured to generate a pulse signal;
the pre-power amplification module is connected to both the pulse signal generation module and the excitation coil, and the pre-power amplification module is configured to amplify the pulse signal to obtain a pulsed voltage signal and apply the pulsed voltage signal to the excitation coil;
the low-pass signal conditioning module is connected to the magnetic sensor, and the low-pass signal conditioning module is configured to perform low-pass filtering and amplification on the voltage signal to obtain a low-pass conditioned signal;
the high-pass signal conditioning module is connected to both the first receiving coil and the second receiving coil, and the high-pass signal conditioning module is configured to perform differential processing on the first voltage signal and the second voltage signal to obtain a differential signal, and perform high-pass filtering and amplification on the differential signal to obtain a high-pass conditioned signal; and
the data acquisition and storage module is connected to both the low-pass signal conditioning module and the high-pass signal conditioning module, and the data acquisition and storage module is configured to acquire and store the low-pass conditioned signal and the high-pass conditioned signal.

12. The composite detection method according to claim 11, wherein the low-pass signal conditioning module comprises a low-pass filter unit and a first amplification unit;
the low-pass filter unit is connected to the magnetic sensor, and the low-pass filter unit is configured to perform the low-pass filtering on the voltage signal to obtain a low-pass filtered signal; and
the first amplification unit is connected to both the low-pass filter unit and the data acquisition and storage module, and the first amplification unit is configured to amplify the low-pass filtered signal to obtain the low-pass conditioned signal.

13. The composite detection method according to claim 11, wherein the high-pass signal conditioning module comprises a high-pass filter unit and a second amplification unit;
the high-pass filter unit is connected to both the first receiving coil and the second receiving coil, and the high-pass filter unit is configured to perform the differential processing on the first voltage signal and the second voltage signal to obtain the differential signal, and perform the high-pass filtering on the differential signal to obtain a high-pass filtered signal; and
the second amplification unit is connected to both the high-pass filter unit and the data acquisition and storage module, and the second amplification unit is configured to amplify the high-pass filtered signal to obtain the high-pass conditioned signal.

14. The composite detection method according to claim 10, wherein the magnet is parallel to an axis of the oil and gas pipeline, the first yoke and the second yoke are both perpendicular to the magnet, the excitation coil is sleeved on a middle of the magnet, the magnetic sensor is located in a middle between the first receiving coil and the second receiving coil, and distances from the magnetic sensor, the first receiving coil, and the second receiving coil to the inner surface of the oil and gas pipeline are the same.

15. The composite detection method according to claim 10, wherein defects that are detectable through the eddy current detection comprise an inner surface crack defect and an inner surface corrosion defect, and defects that are detectable through the magnetic flux leakage detection comprise an inner surface corrosion defect and an outer surface corrosion defect.

16. The composite detection method according to claim 11, wherein a plurality of pulsed excitation probes are provided, and the plurality of pulsed excitation probes are arranged in an array; and
a plurality of integrated electronic systems are provided, and one of the integrated electronic systems corresponds to one of the pulsed excitation probes.

17. The composite detection method according to claim 16, wherein the composite detection apparatus of pulsed eddy current and magnetic flux leakage in an oil and gas pipeline further comprises a detector skeleton and a plurality of probe support arms, and one of the probe support arms corresponds to one of the pulsed excitation probes; and
the plurality of probe support arms are all fixedly mounted on the detector skeleton, the plurality of probe support arms are arranged in an array, the pulsed excitation probe is fixedly mounted on the probe support arm, and the plurality of integrated electronic systems are all fixedly mounted on the detector skeleton.

18. The composite detection method according to claim 17, wherein the detector skeleton is of a circular cylindrical body, and the plurality of probe support arms are uniformly arranged along a circumferential direction of the detector skeleton.
